(19) United States
(12) Patent Application Publication
(10) Pub. No.: US 2002/0102384 A1
(43) Pub. Date: Aug. 1, 2002

(54) Embedded heat pipe sandwich panel constructed using dissimilar materials

(76) Inventors: Scott O. Peck, Palo Alto, CA (US); W. Scott Bonneville, Cupertino, CA (US); John Cooney, Mountain View, CA (US)

Correspondence Address: Joyce Kosinski, Patent Administrator, Loral Space and Communications, 655 Deep Valley Drive, Suite 303, Rolling Hills Estates, CA, 90274, US

(21) Appl. No.: 09/771,766

(22) Filed: Jan. 29, 2001

(51) Int. Cl. B32B 3/20

(52) U.S. Cl. 428/116

(57) ABSTRACT

An embedded heat pipe sandwich panel having components made using dissimilar materials is described. An exemplary embedded heat pipe sandwich panel comprises graphite faceskins secured to aluminum honeycomb core using traditional film adhesives. One or more aluminum heat pipes are embedded in the sandwich panel and thermally coupled to the faceskins using a high thermal conductivity gasket material disposed between the panel faceskins and the heat pipes.

### BACKGROUND

The present invention relates generally to spacecraft, and more particularly, to an improved embedded heat pipe sandwich panel for use on a spacecraft.

The assignee of the present invention manufactures and deploys spacecraft that are used to relay communications signals. The spacecraft have a body with a plurality of equipment panels that hold various subsystems. Many of the subsystems generate heat that must be removed by transferring the heat to radiating panels that direct the heat into space and thus cool the spacecraft and its equipment. A typical configuration consists of a single honeycomb sandwich panel that acts as both the mounting platform for the heat generating equipment and the radiator. The equipment is mounted on the spacecraft interior side of the panel. The exterior side is the radiating surface. Heat pipes are embedded within the sandwich panel to effectively distribute the localized heat from the equipment over the entire panel. This configuration is known as an embedded heat pipe equipment panel.

Embedded heat pipe panels currently used on spacecraft developed by the assignee of the present invention represent the state-of-the-art in aluminum faceskin/aluminum heat pipe technology. These conventional panels are constructed from substantially similar materials, typically aluminum, to eliminate mismatches in the respective coefficients of thermal expansion when using different materials for the faceskin and the heat pipe. It would be desirable to have a heat pipe panel that improves upon aluminum faceskin/aluminum heat pipe technology.

Accordingly, it would be advantageous to have an improved embedded heat pipe sandwich panel for use on a spacecraft. It would also be advantageous to have an improved embedded heat pipe sandwich panel having faceskins and heat pipes constructed from dissimilar materials.

### SUMMARY OF THE INVENTION

The present invention provides for an embedded heat pipe sandwich panel having components made using dissimilar materials. An example of a prior art embedded heat pipe sandwich panel comprises graphite faceskins and aluminum heat pipes built using compliant adhesives. In this example it was necessary to construct the graphite faceskins using highly specific orientations of the graphite fibers in order to accommodate the mismatch in thermal expansion between the aluminum heat pipe and graphite faceskins. The compliant adhesive was necessary to accommodate the remaining mismatch. Rather than adhesively bonding heat pipes into the heat pipe panel, the present invention uses a high thermal conductivity gasket material disposed between the panel faceskins and the heat pipes. Good thermal contact is maintained while simultaneously allowing mechanical expansion of the heat pipes relative to the faceskin.

The present invention allows embedded heat pipe sandwich panels to be constructed using faceskins and heat pipes made from different materials. Prior art panels were constructed from substantially similar materials, such as aluminum, because of mismatches in the respective coefficients of thermal expansion of the faceskin and the heat pipe.

The present invention thus allows construction of heat pipe panels that are not restricted to matched materials. Materials such as graphite may be used in the faceskins together with traditional aluminum heat pipes. The capacity for design flexibility is thus greatly enhanced using the principles of the present invention.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 is a cross sectional side view of an exemplary honeycomb heat pipe sandwich panel in accordance with the principles of the present invention;

FIG. 2 is a cross sectional side view of exemplary crossing honeycomb heat pipe sandwich panels in accordance with the principles of the present invention; and

### DETAILED DESCRIPTION

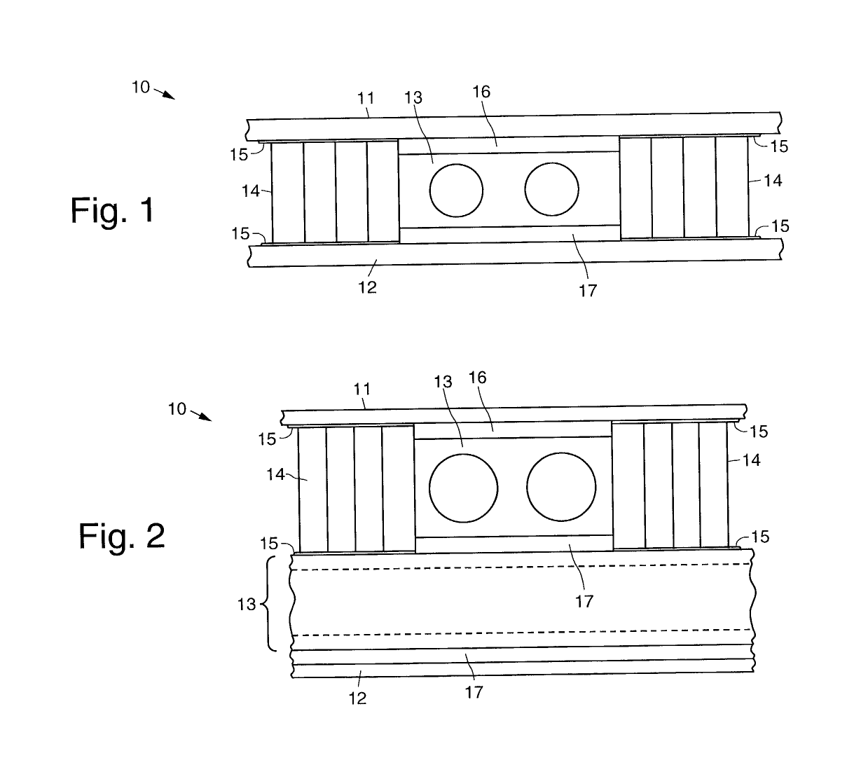

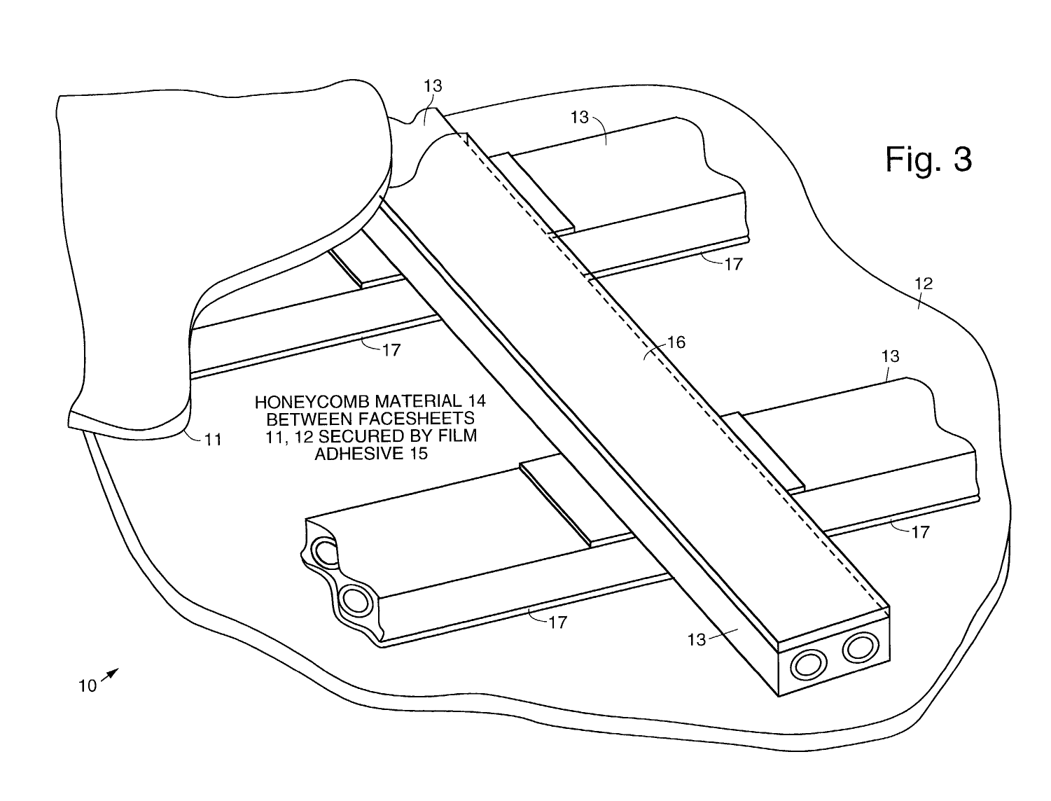

Referring to the drawing figures, FIG. 1 is a cross sectional view of a first embodiment of an exemplary embedded heat pipe honeycomb sandwich panel 10 in accordance with the principles of the present invention. FIG. 2 is a cross sectional side view of a second embodiment of an exemplary embedded crossing honeycomb heat pipe sandwich panel 10 in accordance with the principles of the present invention. FIG. 3 is a perspective view of the embedded crossing honeycomb heat pipe sandwich panel 10 shown in FIG. 2.

The embedded heat pipe sandwich panel 10 comprises inner and outer faceskins 11, 12, embedded heat pipes 13, and a honeycomb core 14 used to separate the faceskins in the sandwich construction. The inner and outer faceskins 11, 12 may be graphite or other similar material. Other materials that may be used for the inner and outer faceskins 11, 12 include aluminum and copper, for example.

The inner and outer faceskins 11, 12 sandwich or embed heat pipes 13 that may be aluminum. Other materials that may be used for the heat pipes 13 include stainless steel and titanium, for example. In general, more than one heat pipe 13 is used in the construction of a heat pipe panel. The heat pipes 13 in a multiple heat pipe panel are typically spaced evenly apart in the panel. Occasionally, the heat pipes 13 may be bent or curved to accommodate specific heat removal requirements. The heat pipes 13 may also be disposed in a crossing arrangement where a plurality of heat pipes are oriented at roughly right angles to the remaining heat pipes so as to form a crossing network of heat pipes 13.

The heat pipe panel includes a honeycomb core 14, which may be aluminum, for example. Other materials that may be used for the honeycomb core include graphite and Kevlar, for example. The inner and outer faceskins 11, 12 are secured to the honeycomb core 14 using a film adhesive 15. The film adhesive may be epoxy or cyanate ester based, for example. The heat pipes 13 are secured within the panel through kinematic mounts. The heat pipes 13 are thermally coupled to the inner and outer faceskins 11,12 using thermally conductive gaskets 16, 17, which are made of a thermally conductive gasket material. The inner and outer thermally conductive gaskets 16, 17 may comprise a thermally conductive gasket material such as Grafoil™, manufactured by Advanced Ceramics Corporation, or Gelvet™, manufactured by Honeywell Electronic Materials, for example. The thermally conductive gasket material is used instead of traditional epoxy adhesive.

The thermal conductivity of the gasket materials used to produce the inner and outer thermally conductive gaskets 16, 17 is an order of magnitude greater than that of epoxy adhesive. Contact conductance is as issue in constructing heat pipe sandwich panels 10, but the Gelvet material in particular has been shown to exhibit exceptional conductivity even at low contact pressures. The advantage of using the thermally conductive gasket material as the inner and outer thermally conductive gaskets 16, 17 is that a sliding interface can be maintained in the longitudinal directions of the gaskets 16, 17.

Thermal expansion of the aluminum heat pipes 13 relative to the graphite (or other) material used as the inner and outer faceskins 11, 12 is accommodated through relative motion of the respective adjacent surfaces. Unlike an epoxy bond, where either a faceskin-to-heat pipe bond failure or a compression failure of the faceskin can occur due to differential thermal expansion at the interface, such failures are avoided in the present heat pipe sandwich panel 10.

One aspect to a successful implementation of the present invention is to hold manufacturing tolerances of the inner and outer faceskins 11, 12 to dimensions of the heat pipes 13 on both sides of the panel 10 so that sufficient pressure is maintained over the surface of the gaskets 16, 17. To do this, the thickness dimension of the honeycomb core 14 should be maintained as well as the thickness of the heat pipes 13.

Exemplary manufacturing dimensions and tolerances for the components of a reduced-to-practice embodiment of the honeycomb heat pipe sandwich panel 10 are as follows. The thicknesses of the inner and outer faceskins 11, 12 are 0.020 inches. The thickness of the honeycomb core 14 is 0.5 inches plus the thicknesses of two compressed gaskets. The dimensions of the heat pipes 13 are 0.5 inches thick by 1.0 inches wide.

Thus, improved embedded heat pipe sandwich panels have been disclosed. It is to be understood that the described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A honeycomb heat pipe panel comprising:
inner and outer faceskins comprising a first material;
heat pipes comprising a second material which has a coefficient of thermal expansion different from the first material and embedded between the inner and outer faceskins;
a honeycomb core comprising a third material;
film adhesive comprising a fourth material used to secure the faceskins to the honeycomb core; and
inner and outer thermally conductive gaskets thermally coupling the inner and outer faceskins to the heat pipe.

2. The heat pipe panel recited in claim 1 wherein the inner and outer faceskins comprise graphite.

3. The heat pipe panel 10 recited in claim 1 wherein one or more heat pipes comprises aluminum.

4. The heat pipe panel 10 recited in claim 1 wherein the honeycomb core comprises aluminum.

5. The heat pipe panel 10 recited in claim 1 wherein the honeycomb core comprises graphite.

6. A heat pipe panel comprising:
inner and outer graphite faceskins;
one or more aluminum heat pipes sandwiched between the inner and outer faceskins; and
inner and outer thermally conductive gaskets thermally coupling the inner and outer faceskins to the one or more aluminum heat pipes.
